(19) United States
(12) Patent Application Publication
(10) Pub. No.: US 2017/0321617 A1
(43) Pub. Date: Nov. 9, 2017

(54) DECEL FUEL CUT-OFF

(71) Applicant: Tula Technology, Inc., San Jose, CA (US)

(72) Inventors: Srihari KALLURI, Ann Arbor, MI (US); Steven E. CARLSON, Oakland, CA (US)

(21) Appl. No.: 15/490,092

(22) Filed: Apr. 18, 2017

Related U.S. Application Data
(63) Continuation of application No. PCT/US17/26937, filed on Apr. 11, 2017.
(60) Provisional application No. 62/331,638, filed on May 4, 2016.

(51) Int. Cl. F02D 41/00; F01N 9/00; F01N 13/08; F02D 15/00; F02M 26/13; F01N 13/10; F01N 3/10

(52) U.S. Cl. CPC F02D 41/0087; F01N 3/101; F01N 9/00; F02D 41/0055; F02D 15/00; F02M 26/13; F01N 13/10; F01N 13/082; F01N 2410/10; F01N 2900/08; F01N 2410/00

(57) ABSTRACT

Various methods and arrangements for improving fuel economy in decel fuel cut-off (DFCO) operation of an internal combustion engine are described. In one aspect, a catalytic converter bypass valve diverts the pumped air in DFCO mode from flowing through a catalytic converter. The diverted, pumped air may flow through a bypass line or be returned to the engine intake manifold through an exhaust gas recirculation return line. Another aspect of the invention relates to directing the diverted pumped air through an emission control device.

### CROSS-REFERENCE TO RELATED APPLICATIONS

The present application is a continuation of PCT Application No. PCT/US17/26937, filed Apr. 11, 2017 and claims priority of U.S. Provisional Patent Application No. 62/331,638, filed on May 4, 2016, both of which are incorporated herein by reference in their entirety.

### FIELD OF THE INVENTION

The present invention relates generally to operation of an internal combustion engine. Various embodiments relate to bypassing a catalytic converter in an engine exhaust system during decel fuel cut-off (DFCO) events.

### BACKGROUND

Most vehicles in operation today (and many other devices) are powered by internal combustion (IC) engines. An internal combustion engine typically has a reciprocating piston which oscillates within a working chamber or cylinder. Combustion occurs within the cylinder and the resulting torque is transferred by the piston through a connecting rod to a crankshaft. For a four-stroke engine, air, and in some cases fuel, is inducted to the cylinder through an intake valve and exhaust combustion gases are expelled through an exhaust valve. In typical engine operation the cylinder conditions vary in a cyclic manner, encountering in order an intake, compression, power, and exhaust stroke in a repeating pattern. Each repeating pattern may be referred to as a working cycle of the cylinder.

Internal combustion engines typically have a plurality of cylinders or other working chambers in which an air-fuel mixture is combusted. The working cycles associated with the various engine cylinders are temporally interleaved, so that the power strokes associated with the various cylinders are approximately equally spaced, delivering the smoothest engine operation. Combustion occurring in the power stroke generates the desired torque as well as various exhaust gases. Some of these gases, such as carbon monoxide, hydrocarbons, and nitrogen oxides are pollutants that are harmful to human health.

Governments have implemented regulations to reduce the emission of such pollutants. As a result, modern vehicles include catalytic converters or some other emission control device, which help to remove pollutants from the engine exhaust. Spark ignition gasoline engines utilize a 3-way catalytic converter in the exhaust stream. During some periods of operation NOₓ is reduced into N₂ and O₂. During other times of operation, a slight excess of oxygen is used to oxidize un-burnt hydrocarbons and carbon monoxide to CO₂ and water. Hence the name, 3-way catalytic converter. The 3-way catalytic converter is capable of these reactions since, in gasoline engines, combustion of the fuel and air mixture can be controlled to oscillate closely about stoichiometric combustion (substantially in the range of Lambda=0.99 to 1.01), producing periodically a slight oxygen excess (for oxidation) or oxygen deficiency (for NOₓ reduction).

Concurrent with efforts to reduce vehicle emissions there has been an on-going effort to improve vehicle fuel efficiency. In particular, one widely employed control method to improve fuel efficiency is use of decel fuel cut-off (DFCO). In this control method when no torque output is required from the engine, engine fueling is disabled or cut-off. During typical drive cycles there are many occasions when no engine torque is required, such as when going downhill or decelerating to a stop or lower vehicle speed. Using DFCO can dramatically reduce fuel consumption during these times, improving overall fuel economy.

A problem that arises during DFCO operation is that the catalytic converter is charged with excess oxygen, since uncombusted air is pumped through the engine during DFCO operation. To rebalance the oxidizing and reducing properties of the catalyst, unburnt fuel is typically introduced into the catalytic converter at the end of a DFCO event to restore the oxidization/reduction balance in the catalyst. Such rebalancing consumes fuel which is not powering the vehicle, thus reducing fuel economy.

To further improve fuel economy there is a need to more efficiently integrate DFCO operation with the emission control systems of modern vehicles.

### SUMMARY

In various embodiments, a system and method for diverting an exhaust stream from a catalytic converter in an engine exhaust system during decel fuel cut-off (DFCO) events is described. Diverting the DFCO exhaust stream, which is almost exclusively pumped air, can improve fuel efficiency.

In one aspect, a vehicle includes an internal combustion engine having an exhaust system. The exhaust system includes an exhaust manifold connected to exhaust ports of the engine cylinders, an exhaust line connecting the exhaust manifold to a catalytic converter, a bypass line connected to the exhaust line between the engine and the catalytic converter, a tailpipe connected to the exhaust stream outlet of the catalytic converter, a catalytic converter bypass valve mounted in the exhaust line between the engine and the catalytic converter, and a bypass shut off valve in the bypass line. The catalytic converter bypass valve and bypass shut off valve can be opened and closed cooperatively to divert the engine exhaust stream from the catalytic converter to the bypass line.

In another aspect, a vehicle includes an internal combustion engine having an air inlet and exhaust system. The air inlet and exhaust system includes an exhaust manifold connected to exhaust ports of the engine cylinders, an exhaust line connecting the exhaust manifold to a catalytic converter, a tailpipe connected to the exhaust stream outlet of the catalytic converter, an exhaust gas recirculation (EGR) return line connecting the exhaust line to an intake manifold, a catalytic converter bypass valve mounted in the exhaust line between the engine and the catalytic converter, and an EGR valve mounted in the EGR return line between the exhaust line and the intake manifold. The catalytic converter bypass valve and EGR valve can be opened and closed cooperatively to divert the engine exhaust stream from the catalytic converter to the engine intake manifold.

In yet another aspect, a method of controlling an internal combustion engine having a plurality of cylinders which vent into an exhaust system having a catalytic converter is described. During deceleration or coasting fuel flow to the cylinders of the internal combustion engine may be cut off to place the engine in DFCO mode. Substantially simultaneously with placing the engine in DFCO mode a catalytic converter bypass valve in the exhaust system is closed so as to have the exhaust stream diverted from the catalytic converter while the engine remains in DFCO mode. The catalytic converter bypass valve is opened substantially simultaneously with the engine leaving DFCO mode. The catalytic converter bypass valve works cooperatively with other valves that are present in the engine air inlet and exhaust system to divert the DFCO exhaust stream in an appropriate manner. In some embodiments, the diverted exhaust stream is directed through an emission control device.

The various aspects and features described above may be implemented separately or in any combination.

### BRIEF DESCRIPTION OF THE DRAWINGS

The invention and the advantages thereof, may best be understood by reference to the following description taken in conjunction with the accompanying drawings in which:

FIG. 1 is a diagram of a representative prior art internal combustion engine showing an air inlet and exhaust system.

FIG. 2 is graph showing the mass of air pumped through an engine during DFCO events for a representative drive cycle.

FIG. 3 is a diagram of an internal combustion engine showing an air inlet and exhaust system according to an embodiment of the present invention.

FIG. 4 is a diagram of an internal combustion engine showing an air inlet and exhaust system according to an embodiment of the present invention.

FIG. 5 is a diagram of an internal combustion engine showing an air inlet and exhaust system according to an embodiment of the present invention.

FIG. 6 is a diagram of an internal combustion engine showing an air inlet and exhaust system according to an embodiment of the present invention.

In the drawings, like reference numerals are sometimes used to designate like structural elements. It should also be appreciated that the depictions in the figures are diagrammatic and not to scale.

### DETAILED DESCRIPTION

As noted in the Background section, a catalytic converter needs to be balanced in its oxidation and reduction reactions if it is to be effective at removing pollutants from vehicle exhaust. To achieve this balance after a DFCO event, fuel is typically injected into the catalytic converter. The invention described herein reduces or eliminates the need to rebalance the catalytic converter after a DFCO event. It should be appreciated that the term DFCO as used herein applies to any situation where fuel is not delivered to the cylinders of a rotating engine, but the cylinder piston and valves continue to operate. This mode of operation is sometimes described as deceleration fuel shut off or DFSO.

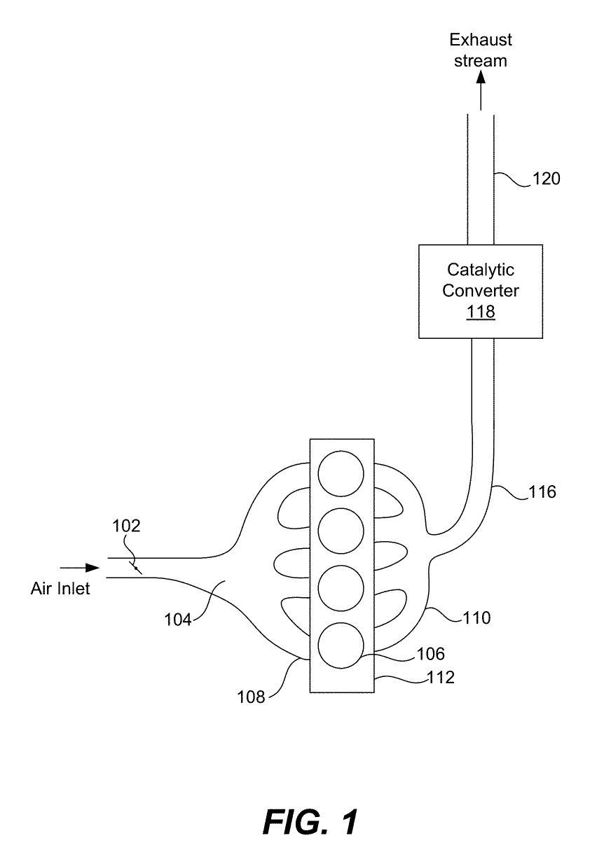

FIG. 1 is a representative block diagram of a prior art vehicle internal combustion engine showing its air inlet and exhaust systems. Air enters the system through an air inlet passing by a throttle blade 102. The throttle blade opens and closes in a continuous manner to control the amount of air entering the engine 112. The air passes through an intake manifold 104 and then is distributed to the cylinders 106 by a plurality of intake runners 108. Air flow into and out of the cylinders 106 is controlled by intake and exhaust valves (not shown in FIG. 1). In the cylinders 106 air is combusted with fuel to produce torque that propels the vehicle. The combusted air forms an exhaust stream that leaves the cylinders via the exhaust valves (not shown in FIG. 1) and enters an exhaust manifold 110. The exhaust stream travels from the exhaust manifold 110 down an exhaust line 116 until reaching a catalytic converter 118. The catalytic converter performs oxidation and/or reductions reactions to reduce undesirable pollutants in the exhaust stream. The exhaust stream is then vented to the atmosphere through a tailpipe 120.

During normal driving cycles there are many instances when engine torque is not required. Operating the engine in decel fuel cut-off (DFCO) mode when no engine torque is required is a known method of improving fuel economy. While the engine is operating in DFCO mode it is pumping air through the cylinders and out the exhaust system.

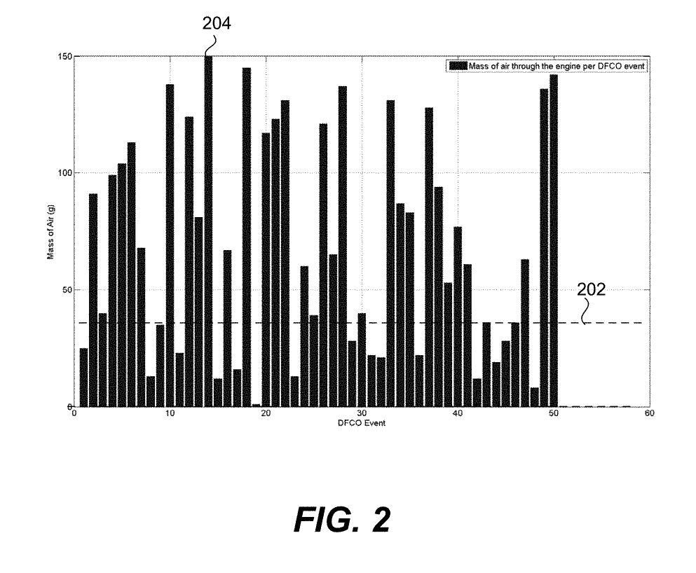

FIG. 2 illustrates the mass of air pumped through a vehicle exhaust system during DFCO events in a representative drive cycle of a representative vehicle. The events are numbered in chronological order as they appear in the drive cycle. For this drive cycle there are 50 DFCO events. The vertical axis is the air mass pumped through the engine and catalytic converter in each DFCO event. The length of the DFCO events varies, but most are in the range of 1.5 to 2 seconds, although some may be approximately 30 seconds long. Obviously events that pump more air through the engine, such as event 204, involve longer deceleration intervals and/or higher engine speeds.

As noted in the Background, after a DFCO event unburnt fuel is typically introduced into the catalytic converter to reestablish a balance between oxidation and reduction reactions. If the catalytic converter has been fully oxidized, i.e. large amounts of oxygen have been pumped through, than a relatively large amount of fuel is required to reestablish the balance. The Applicant has determined that for the representative test vehicle whose results are shown in FIG. 2 approximately 35 g of air pumped through the catalytic converter will fully oxidize the converter. This mass of air is denoted by dashed line 202 in FIG. 2. After each DFCO event extra fuel is typically injected into the catalytic converter to rebalance the converter.

DFCO mode only saves fuel for the 32 events where the air mass exceeds line 202. For these events the excess air pumped through the catalytic converter, i.e. the amount of air above line 202, does not need to be compensated by adding fuel to the catalytic converter after the DFCO event. The amount of excess oxygen pumped through the converter does not change the oxidation/reduction balance, since the converter is oxygen saturated once the air mass exceeds line 202. The 18 DFCO events that fall on or below line 202 result in little or no fuel savings, since the catalytic converter must be rebalanced after most or all of these events. Rebalancing is generally required for both DFCO events falling above or on line 202 and DFCO events falling below line 202.

In this example, the need to rebalance the catalytic converter consumes an amount of fuel only slightly less than that saved by operating in DFCO mode. In other words if the need to rebalance the catalytic converter could be reduced or eliminated the fuel savings from DFCO mode could more than double. Obviously the mass of air pumped through the catalytic converter and the DFCO fuel savings are dependent on engine displacement, operating engine speed range, catalytic converter size, and other variables. It should be noted that the DFCO fuel savings also vary with the drive cycle, but fuel savings from prior art DFCO mode operation is in the range of 1% to 4%, so it is anticipated that use of the invention described herein may approximately double these values. Described herein is an apparatus and method to realize a fuel efficiency improvement from operation in DFCO mode by eliminating or reducing the need to rebalance the catalytic converter after a DFCO event.

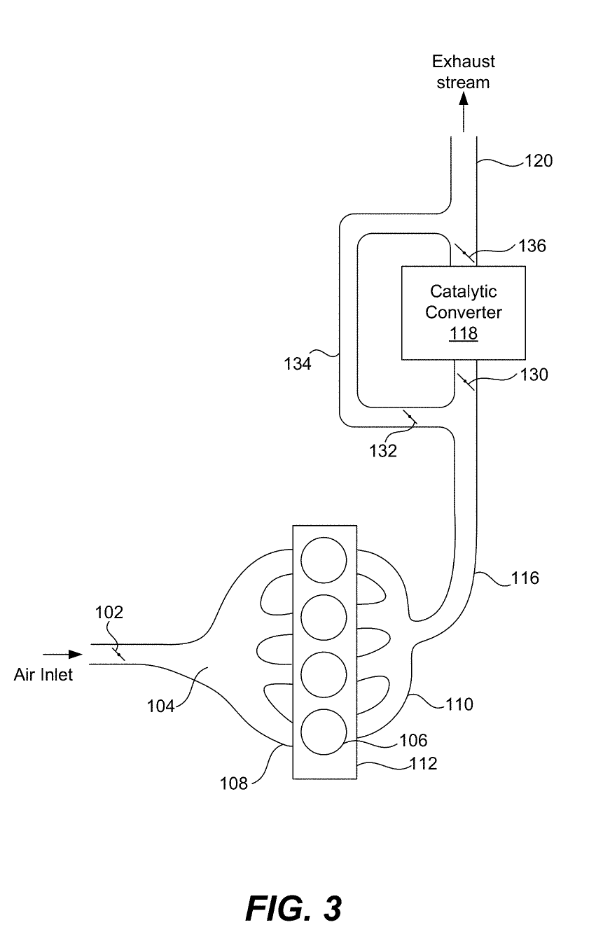

FIG. 3 shows an engine, air inlet, and exhaust system according to an embodiment of the present invention. Many elements in FIG. 3 are identical to those shown in FIG. 1 and their description will not be repeated. New elements shown in FIG. 3 include a catalytic converter bypass valve 130, a bypass shut off valve 132, a bypass line 134, and an optional catalytic converter isolation valve 136. In operation, when the engine 112 enters DFCO mode the catalytic converter bypass valve 130 closes and the bypass shut off valve 132 opens, diverting air flow around the catalytic converter through bypass line 134. The bypassed air flow may enter tailpipe 120 as shown in FIG. 3 or alternatively may be vented to the atmosphere without going through tailpipe 120. Optional catalytic converter isolation valve 136 is normally open, but closes when the vehicle enters DFCO mode. With catalytic converter isolation valve 136 closed and catalytic converter bypass valve 130 valve closed little or no oxygen can reach the catalytic converter effectively preserving the oxidation/reduction balance in the converter for the duration of the DFCO event. Once the DFCO event ends both catalytic converter isolation valve 136 and catalytic converter bypass valve 130 may open and the bypass shut off valve 132 closes returning the exhaust stream flow through the catalytic converter 118. Catalytic converter bypass valve 130, bypass shut off valve 132, and converter isolation valve 136 may all be two position valves having an open and closed position. Unlike the throttle blade 102 they do not need to be controlled in a continuous manner in some embodiments.

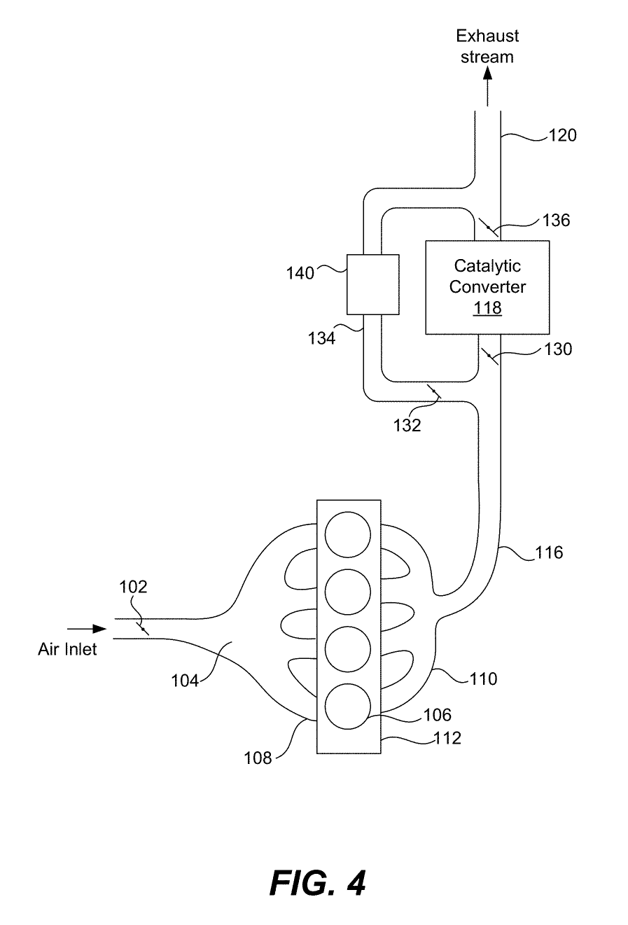

FIG. 4 shows an engine, air inlet, and exhaust system according to another embodiment of the present invention. Many elements in FIG. 4 are identical to those shown in FIGS. 1 and 3 and their description will not be repeated. The additional element in FIG. 4 is bypass emission control device 140 located in the bypass line 134. The bypass emission control device may be a 3-way catalytic converter, similar in catalyst, but having smaller capacity than catalytic converter 118. Alternatively bypass emission control device 140 may be some other type of emission control device. The purpose of emission control device 140 is to reduce or eliminate any undesirable emissions in the air pumped through the engine during DFCO mode operation. Even though there is no combustion in DFCO mode, some pollutants, such as unburnt fuel from prior engine cycles or vaporized engine lubricant may be present in the DFCO exhaust stream. Placing a small bypass emission control device 140 in the bypass line 134 can clean up these pollutants. Note that if bypass emission control device 140 is a 3-way catalyst, the air mass pumped through the bypass emission control device 140 required to fully oxidize the device catalyst may be much smaller than that required for the catalytic converter 118. Effectively, this lowers line 202 in FIG. 2 increasing the potential fuel savings from operating in DFCO mode.

Bypass emission control device 140 may be positioned in contact with catalytic converter 118, so that bypass emission control device 140 is heated by catalytic converter 118. In other embodiments, bypass shut off valve 132 and/or catalytic converter bypass valve 130 may not be a simple on/off valve, but may have one or more positions or may be controlled in a continuous manner. By varying the relative opening and closing of these valves, the ratio of the exhaust stream between the catalytic converter 118 and emission control device 140 may be controlled. For example, when the engine is not operating in DFCO mode most of the exhaust stream may flow through the catalytic converter 118, but a small fraction may be diverted to emission control device 140 where hot exhaust gases will elevate the temperature of emission control device 140. When the engine enters DFCO mode catalytic converter bypass valve 130 will close and bypass shut off valve 132 will open, so substantially all the DFCO exhaust stream flows through emission control device 140.

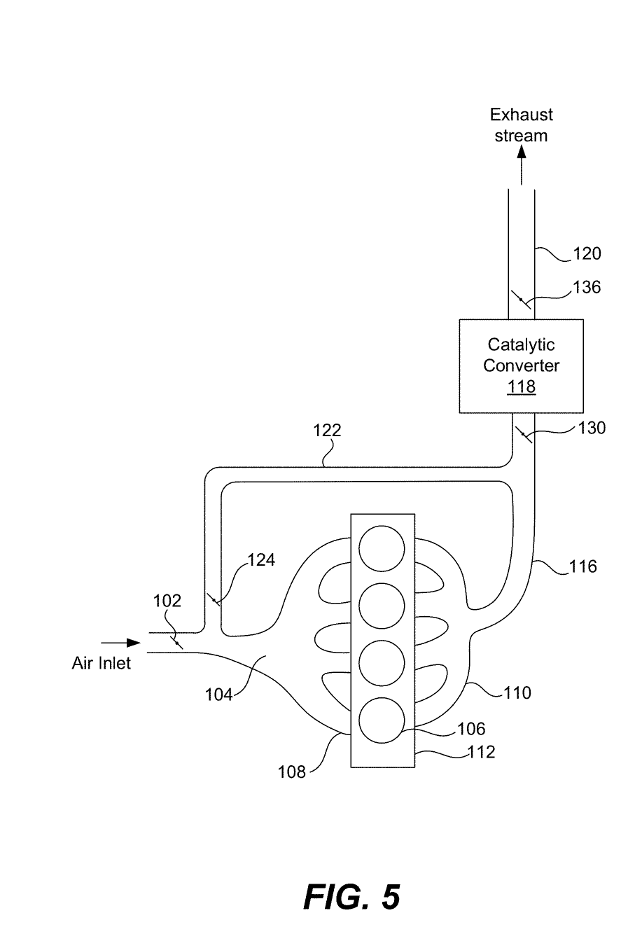

FIG. 5 shows an engine, air inlet, and exhaust system according to another embodiment of the present invention. Many elements in FIG. 5 are identical to those shown in FIGS. 1, 3 and 4 and their description will not be repeated. FIG. 5 shows an external exhaust gas recirculation (EGR) system integrated into the air inlet and exhaust system. An EGR system is often incorporated in modern vehicles. The EGR system includes a return line 122 that allows flow of exhaust gas from the exhaust line 116 into the intake manifold 104. For an operating, naturally aspirated engine, intake manifold 104 is at a lower pressure than ambient and thus flow is between exhaust line 116 and intake manifold 104. An EGR valve 124 controls exhaust gas flow. In some cases during normal, i.e. non-DFCO mode operation, about 5 to 15% of the gas entering the cylinders 106 consists of exhaust gases. Introduction of exhaust gases into the cylinders can improve fuel efficiency and reduce NOₓ emissions.

The external EGR system can be utilized in DFCO mode operation to improve fuel efficiency. In FIG. 5 the exhaust system no longer has the bypass shut off valve 132 and bypass line 134. As in prior embodiments, when the engine enters DFCO mode catalytic converter bypass valve 130 closes. Closing catalytic converter bypass valve 130 diverts the exhaust stream into EGR return line 122. EGR valve 124 may be fully opened in DFCO mode so that substantially all the air pumped through the engine in DFCO mode is returned to the intake manifold 104. Effectively, the air is being circulated in a closed loop around the engine. An advantage of the embodiment shown in FIG. 5 is that it may utilize hardware, such as EGR return line 122 and EGR valve 124, which are already present in some modern engines. It should be appreciated, that the gas handling capabilities of EGR return line 122 and EGR valve 124 may need to be increased over those typically used to accommodate the larger gas flow rates of the present invention. A separate bypass design for pumped DFCO air, that parallels that used by an external EGR, may be used in some embodiments. This parallel system may be used with or without an external EGR system. An advantage of a design where the DFCO pumped air is diverted back into the intake manifold is that it may not require an additional emission control device.

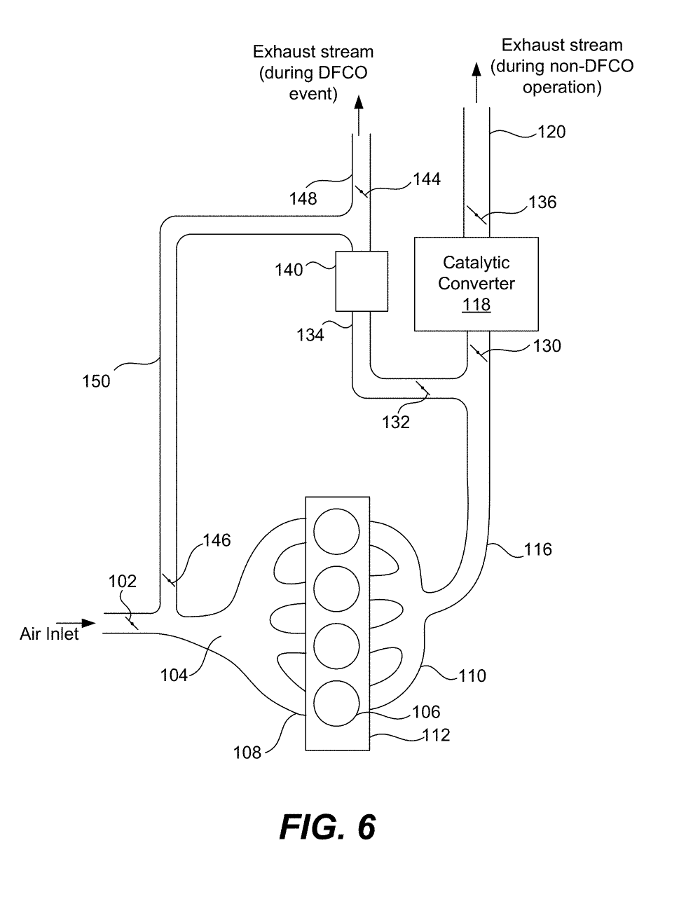

FIG. 6 shows an engine, air inlet, and exhaust system according to another embodiment of the present invention. Many elements in FIG. 6 are identical to those shown in FIGS. 1, 3, 4 and 5 their description will not be repeated. Unlike the prior figures, the embodiment shown in FIG. 6 has a separate auxiliary tailpipe 148. During a DFCO event the pumped air flows out into the ambient atmosphere through the auxiliary tailpipe 148 instead of tailpipe 120. A return line 150 connects the auxiliary tail pipe 148 to the intake manifold 104 when return line valve 146 is open. Emission control device 140 may contain activated charcoal or some other medium, which captures and temporarily stores hydrocarbons that may be present in the DFCO pumped air exhaust stream. These hydrocarbons can be purged under appropriate operating conditions by opening slightly bypass shut off valve 132, closing auxiliary tailpipe valve 144, and opening return valve 146. In this valve configuration, some of the exhaust stream will be diverted from catalytic converter 118 and tailpipe 120 and instead flow through emission control device 140, through return line 150, return line valve 146 and back into intake manifold 104. The hydrocarbons temporary stored in emission control device 140 may be released by this flow and burnt in the process of normal engine combustion.

It should be also appreciated that any of the operations described herein may be stored in a suitable computer readable medium in the form of executable computer code. The operations are carried out when a processor executes the computer code. The computer code may be incorporated in an engine controller that coordinates entry into and out of DFCO mode and the opening and closing of the exhaust system valves.

The invention has been described primarily in the context of gasoline powered, 4-stroke piston engines suitable for use in motor vehicles. However, it should be appreciated that the described methods and apparatus are very well suited for use in a wide variety of internal combustion engines. These include engines for virtually any type of vehicle—including cars, trucks, boats, aircraft, motorcycles, scooters, etc.; and virtually any other application that involves the firing of working chambers and utilizes an internal combustion engine. The various described approaches work with engines that operate under a wide variety of different thermodynamic cycles—including virtually any type of two stroke piston engines, diesel engines, Otto cycle engines, Dual cycle engines, Miller cycle engines, Atkinson cycle engines, Wankel engines and other types of rotary engines, mixed cycle engines (such as dual Otto and diesel engines), hybrid engines, radial engines, etc. It is also believed that the described approaches will work well with newly developed internal combustion engines regardless of whether they operate utilizing currently known, or later developed thermodynamic cycles.

In addition to using this invention with a conventionally controlled engine having all cylinders firing when engine torque is requested, the invention described herein may be used with a variable displacement or skip fire controlled engine. In both of these control modes one or more cylinders may be deactivated when torque requirements are low. These deactivated cylinders may have their associated intake and/or exhaust valves closed so that they do not pump air through the engine. A skip fired controlled engine may operate in DCCO (decel cylinder cut off) mode when no engine torque is required. This control mode is described in Applicant's co-pending patent application Ser. No. 15/009,533, which is incorporated herein by reference This control mode contrasts with DFCO mode where cylinders only have their fuel cut-off and continue to pump air. In a skip fire controlled engine some cylinders may only have fuel shut off while other cylinders may have both fuel and air shut off (deactivated). If operating in this mode, the air pumped through the skipped, but not deactivated cylinders, may be diverted from the catalytic converter using the methods and apparatus described herein. When a skip fire controlled engine leaves DCCO mode it may be desirable to operate briefly in DFCO mode to pump down the intake manifold. Reducing the intake manifold pressure can help to mitigate a torque bump associated with returning one or more cylinders to a firing state. In this case exhaust flow through the catalytic converter may be restored substantially concurrently with cylinder firing.

Although only a few embodiments of the invention have been described in detail, it should be appreciated that the invention may be implemented in many other forms without departing from the spirit or scope of the invention. For example, most modern vehicles use an evaporative fuel canister to capture fuel evaporating from the fuel tank. The evaporative fuel canister and its associated connections could be modified to filter the pumped air during a DFCO event. Hydrocarbons in the pumped air may be captured and stored in the evaporative fuel canister until they are disposed of by purging the evaporative fuel canister through the intake manifold. While the engine has been described as having cylinders, the engine may use some other type of combustion chamber. Therefore, the present embodiments should be considered illustrative and not restrictive and the invention is not to be limited to the details given herein.

What is claimed is:

1. A vehicle having an internal combustion engine with a plurality of cylinders and an exhaust system, the exhaust system comprising:
an exhaust manifold connected to exhaust ports of the engine cylinders,
an exhaust line connecting the exhaust manifold to an input of a catalytic converter,
a bypass line connected to the exhaust line between the engine and the catalytic converter,
a tailpipe connected to the exhaust stream outlet of the catalytic converter,
a catalytic converter bypass valve mounted in the exhaust line between the engine and the catalytic converter, and
a bypass shut off valve in the bypass line.

2. An exhaust system as recited in claim 1 wherein a catalytic converter isolation valve is located in the tailpipe.

3. An exhaust system as recited in claim 1 wherein an emission control device is located in the bypass line.

4. An exhaust system as recited in claim 3 wherein the emission control device is in contact with the catalytic converter.

5. An exhaust system as recited in claim 3 wherein the emission control device uses a 3-way catalyst.

6. An exhaust system as recited in claim 3 wherein the emission control device vents into an auxiliary tail pipe.

7. An exhaust system as recited in claim 6 wherein the auxiliary tail pipe includes an auxiliary tailpipe valve that can shut off gas flow through the auxiliary tailpipe.

8. An engine as recited in claim 1 wherein the engine is capable of being controlled in a variable displacement mode or a skip fire mode.

9. A method of controlling an internal combustion engine having a plurality of cylinders which vent into an exhaust system having a catalytic converter comprising;
cutting off fuel flow to the cylinders of the internal combustion engine to place the engine in decel fuel cut-off (DFCO) mode,
closing a catalytic converter bypass valve in the exhaust system so as to have an exhaust stream diverted from the catalytic converter while the engine remains in DFCO mode, and
opening the catalytic converter bypass valve when the engine leaves decel fuel cut off mode.

10. A method as recited in claim 9 wherein a catalytic converter isolation valve is closed and opened substantially simultaneously with the catalytic converter bypass valve so as to isolate the catalytic converter when the engine is in DFCO mode.

11. A method as recited in claim 9 wherein an engine gas recirculation (EGR) valve is opened substantially simultaneously with the closure of the catalytic converter bypass valve so as to have the exhaust stream flow through an EGR return line.

12. A method as recited in claim 9 wherein a bypass shut off valve is opened substantially simultaneously with the closure of the catalytic converter bypass valve so as to have the exhaust stream flow through a bypass line.

13. A method as recited in claim 9 wherein some of the exhaust stream flows through a bypass line under all engine operating conditions.

14. A method as recited in claim 13 wherein an emission control device is situated in the bypass line.

15. A method as recited in claim 9 wherein the cylinders of the internal combustion engine can be deactivated.

16. A method as recited in claim 15 wherein operation in DFCO mode follows operation in decel cylinder cut off (DCCO) mode.

17. A vehicle having an internal combustion engine with a plurality of cylinders and an air inlet and exhaust system, the air inlet and exhaust system comprising:
an exhaust manifold connected to exhaust ports of the engine cylinders,
an exhaust line connecting the exhaust manifold to an input of a catalytic converter,
a tailpipe connected to the exhaust stream outlet of the catalytic converter,
an exhaust gas recirculation (EGR) return line connecting the exhaust line to an intake manifold,
a catalytic converter bypass valve mounted in the exhaust line between the engine and the catalytic converter, and
an EGR valve mounted in the EGR return line between the exhaust line and the intake manifold.

18. An exhaust system as recited in claim 17 wherein a catalytic converter isolation valve is located in the tailpipe.

19. An exhaust system as recited in claim 17 wherein an emission control device is located in the bypass line.

20. An exhaust system as recited in claim 19 wherein the emission control device is in contact with the catalytic converter.
